(19) United States
(12) Patent Application Publication
(10) Pub. No.: US 2014/0215315 A1
(43) Pub. Date: Jul. 31, 2014

(54) WEBPAGE CONVERSION SYSTEM AND METHOD

(71) Applicant: HON HAI PRECISION INDUSTRY CO., LTD., New Taipei (TW)

(72) Inventors: KUAN-CHIAO PENG, New Taipei (TW); CHIEN-FA YEH, New Taipei (TW); CHUNG-I LEE, New Taipei (TW); TING-YU WEN, New Taipei (TW)

(73) Assignee: HON HAI PRECISION INDUSTRY CO., LTD., New Taipei (TW)

(21) Appl. No.: 14/132,896

(22) Filed: Dec. 18, 2013

(30) Foreign Application Priority Data
Jan. 25, 2013 (TW) 102102796

(51) Int. Cl. G06F 17/22

(52) U.S. Cl. CPC G06F 17/2247
USPC 715/239

(57) ABSTRACT

A computer obtains language configuration and language tags of a webpage in a browser. The computer searches for a language file in the computer according to the language configuration, and replaces the language tags in the webpage with the language tags in the language file. The computer obtains a serial number of the database according to the language configuration, and connects to the database according to the serial number of the database and displays data from the database in the webpage.

### BACKGROUND

1. Technical Field

The embodiments of the present disclosure relate to information processing technology, and particularly to a webpage conversion system and method.

2. Description of Related Art

A website may be displayed in different languages and for different people. For example, if the website is displayed in Chinese, the website may be for the people who know Chinese. If the website is displayed in English, the website may be for the people who know English. However, at present, most website establishes an independent page for each language, which may result in difficulty of maintaining the website. Therefore, there is room for improvement in the art.

### BRIEF DESCRIPTION OF THE DRAWINGS

FIG. 1 is a block view of one embodiment of a computer including a webpage conversion system.

FIG. 2 is a block diagram of one embodiment of function modules of the webpage conversion system included in the computer in FIG. 1.

FIG. 3 is a flowchart of one embodiment of a webpage conversion method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

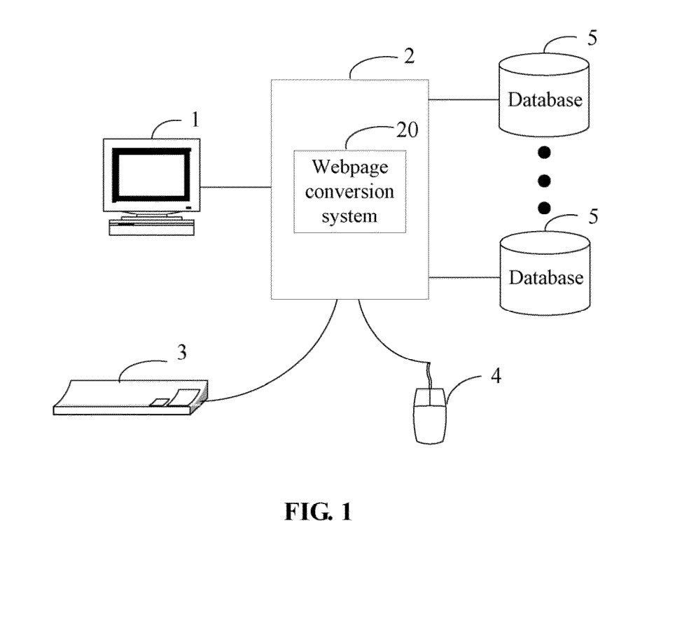

FIG. 1 is a block diagram of one embodiment of a computer 2. The computer 2 includes a webpage conversion system 20. A plurality of peripherals are electronically connected to the computer 2, such as a display device 1, a keyboard 3, and a mouse 4. The peripherals may be used to input or as output for various computer signals or software interfaces. The computer 2 electronically connects to one or more databases 5 using open database connectivity (ODBC) or JAVA database connectivity (JDBC), for example.

Each database 5 may store data corresponding to a specific language. The language may be, but is not limited to, Chinese, English, Japanese, or any other language. For example, if the computer 2 is connected to three databases 5, namely database A, database B, and database C. The database A may store data corresponding to Chinese, the database B may store data corresponding to English, and the database C may store data corresponding to Japanese.

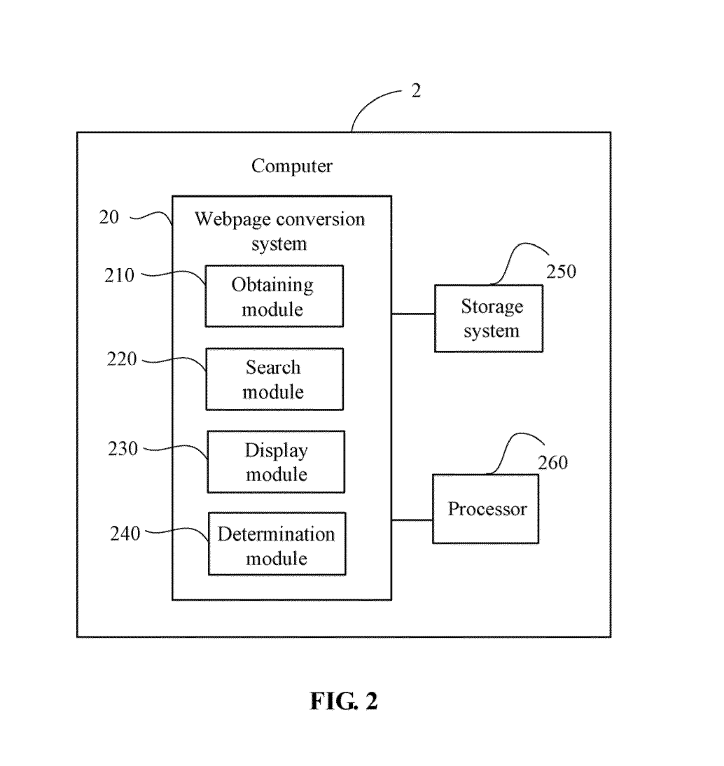

FIG. 2 is a block diagram of one embodiment of function modules of the webpage conversion system 20. In one embodiment, the webpage conversion system 20 includes an obtaining module 210, a search module 220, a display module 230, and a determination module 240. The computer 2 further includes a storage system 250, and at least one processor 260. The modules 210-240 may include computerized code in the form of one or more programs that are stored in the storage system 250. The computerized code includes instructions that are executed by the at least one processor 260 to provide functions for the modules 210-240. The storage system 250 may be a memory, such as an EPROM memory chip, hard disk drive (HDD), or flash memory stick.

The obtaining module 210 obtains language configuration in a browser. The language configuration corresponds to a language and includes an identifier of the language. The identifier of the language is predetermined by a user. For example, the identifier of Chinese is donated by letters “CN,” the identifier of English is donated by the letters “EN,” and the identifier of Japanese is donated by the letters “JP.” A user is capable of changing the language configuration. For example, the user may change the identifier from “EN” to “CN.”

The obtaining module 210 obtains language tags of a webpage in the browser. The language tags indicate positions in the webpage. For example, the language tags indicate where data (e.g., pictures or words) of the webpage is positioned in the webpage. The obtaining module 210 converts the webpage into a format of source code, and obtains the language tags from the source code of the webpage. The language tags may be, but are not limited to, a HTML tag including span elements. The language tags also include specific characters (e.g., “lang”), the obtaining module 210 obtains the language tags by searching the specific characters in the source code of the webpage. For example, one language tag is searched in the source code of the webpage, such as, “<span lang=“lang_spanusermail”> <span>” of the HTML syntax. The language tag may contain a piece of information. For example, the language tag “<span lang=“lang_spanusermail”> <span>” contains the piece of information “Email: a@b.com,” which is changed to “<span lang=“lang_spanusermail”> Email: a@b.com <span>.”

The search module 220 searches for a language file according to the language configuration. The language file may be but is not limited to, a TXT file, a WORD file, or a PDF file. The language file includes the language tags. The language file corresponds to language configuration, and the language tags in the language file also correspond to the language configuration. For example, if the language configuration corresponds to English, then the language file corresponds to English, and all pieces of information in the language file are also written in English. The language file is stored in the computer 2.

The display module 230 replaces the language tags in the webpage with the language tags in the language file.

The obtaining module 210 obtains the serial number of the database 5 according to the language configuration.

The display module 230 connects to the database 5 according to the serial number of the database 5 and displays data from the database 5 in the webpage.

The determination module 240 determines if the language configuration is reset. For example, assuming that the language configuration currently corresponds to English, if the user reset the language configuration from English to Chinese, the language configuration is reset.

The display module 230 replaces the language tags in the webpage using the language tags in the language file corresponding to the reset language configuration, and displays data corresponding to the reset language configuration, in response to a determination that the language configuration is reset. In one embodiment, if the language configuration is reset to Chinese from English, the display module 230 searches for the language file corresponding to Chinese, connects to the database 5 corresponding to Chinese, and displays the data corresponding to Chinese from the database 5 in the webpage.

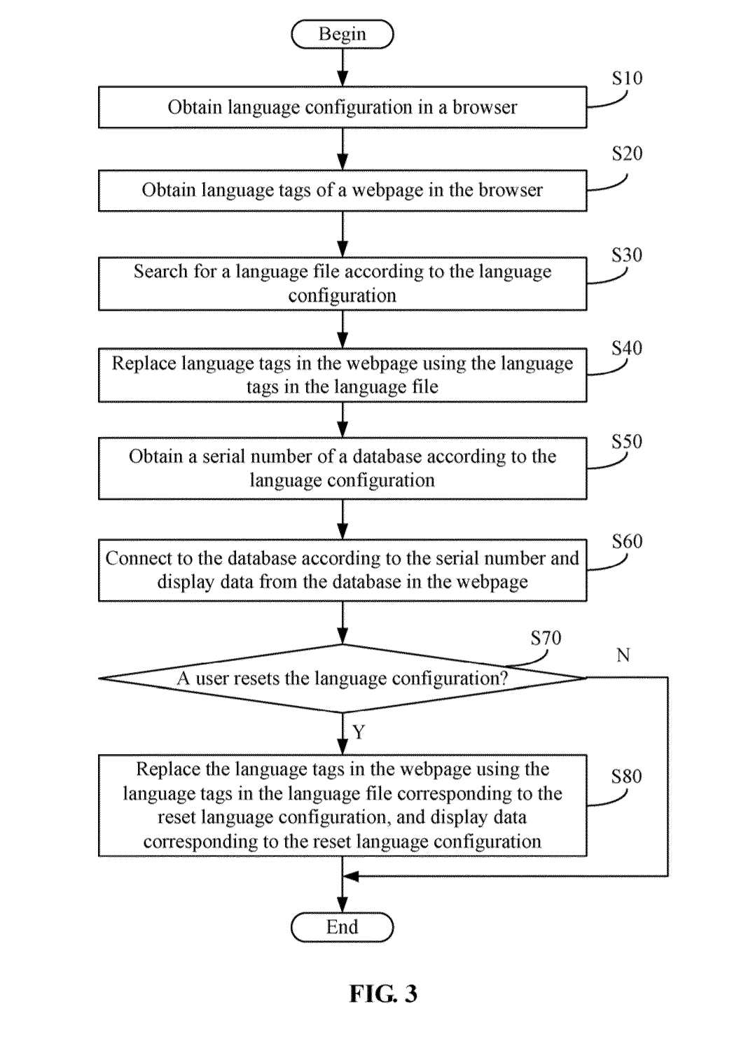

FIG. 3 is a flowchart of one embodiment of a webpage conversion method. Depending on the embodiment, additional steps may be added, others deleted, and the ordering of the steps may be changed.

In step S10, the obtaining module 210 obtains language configuration in a browser. For example, the identifier of Chinese is donated by letters “CN,” the identifier of English is donated by the letters “EN,” and the identifier of Japanese is donated by the letters “JP.”

In step S20, the obtaining module 210 obtains language tags of a webpage in the browser. The language tags indicate positions in the webpage. For example, the language tags indicate where data (e.g., pictures, or words) of the webpage is positioned in the webpage. The obtaining module 210 converts the webpage into a format of source code, and obtains the language tags from the source code of the webpage. The language tags may be, but are not limited to, a HTML tag including span elements. The language tags also include specific characters (e.g., “lang”), the obtaining module 210 obtains the language tags by searching the specific characters in the source code of the webpage. For example, one language tag is searched out in the source code of the webpage, such as, “<span lang=“lang_spanusermail”> <span>.” The language tag may contain a piece of information. For example, the language tag “<span lang=“lang_spanusermail”> <span>” contains the piece of information “Email: a@b.com,” which is changed to “<span lang=“lang_spanusermail”> Email: a@b.com <span>.”

In step S30, the search module 220 searches for a language file according to the language configuration. As mentioned above, if the language configuration corresponds to English, then the language file corresponds to English, and all pieces of information in the language file are also written in English. The language file may be also stored into the database 5 corresponding to the language. For example, if the language file corresponds to English, the language file is stored into the database 5 corresponding to English.

In step S40, the display module 230 replaces the language tags in the webpage with the language tags in the language file.

In step S50, the obtaining module 210 obtains the serial number of the database 5 according to the language configuration.

In step S60, the display module 230 connects to the database 5 according to the serial number of the database 5 and displays data from the database 5 in the webpage.

In step S70, the determination module 240 determines if the language configuration is reset. In one embodiment, if the language configuration is reset, the procedure goes to step S80. Otherwise, if the language configuration is not reset, the procedure ends.

In step S80, the display module 230 replaces the language tags in the webpage using the language tags in the language file corresponding to the reset language configuration, and displays data corresponding to the reset language configuration.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer, comprising:
at least one processor; and
a storage system that stores one or more programs, when executed by the at least one processor, cause the at least one processor to perform a webpage conversion method, the method comprising:
obtaining language configuration in a browser installed in the computer;
obtaining language tags of a webpage in the browser;
searching for a language file in the computer according to the language configuration;
replacing the language tags in the webpage with the language tags in the language file;
obtaining a serial number of a database according to the language configuration; and
connecting to the database according to the serial number of the database and displaying data from the database in the webpage.

2. The computer of claim 1, further comprising:
replacing the language tags in the webpage using the language tags in the language file corresponding to reset language configuration, and displaying data corresponding to the reset language configuration, in response to a determination that the language configuration is reset.

3. The computer of claim 1, wherein the language configuration corresponds to a language and comprises an identifier of the language.

4. The computer of claim 1, wherein the webpage is converted into a format of source code, and the language tags in the webpage are obtained from the source code of the webpage.

5. The computer of claim 1, wherein the language file corresponds to language configuration, and the language tags in the language file also correspond to the language configuration.

6. A webpage conversion method implemented by a computer, the method comprising:
the computer obtains language configuration in a browser installed in the computer;
the computer obtains language tags of a webpage in the browser;
the computer searches for a language file in the computer according to the language configuration;
the computer replaces the language tags in the webpage with the language tags in the language file;
the computer obtains a serial number of a database according to the language configuration; and
the computer connects to the database according to the serial number of the database and displays data from the database in the webpage.

7. The method of claim 6, the method further comprising:
the computer replaces the language tags in the webpage using the language tags in the language file corresponding to reset language configuration, and displaying data corresponding to the reset language configuration, in response to a determination that the language configuration is reset.

8. The method of claim 6, wherein the language configuration corresponds to a language and comprises an identifier of the language.

9. The method of claim 6, wherein the webpage is converted into a format of source code, and the language tags in the webpage are obtained from the source code of the webpage.

10. The method of claim 6, wherein the language file corresponds to language configuration, and the language tags in the language file also correspond to the language configuration.

11. A non-transitory computer-readable medium having stored thereon instructions that, when executed by a computer, causing the computer to perform a webpage conversion method, the method comprising:
obtaining language configuration in a browser installed in the computer;
obtaining language tags of a webpage in the browser;
searching for a language file in the computer according to the language configuration;
replacing the language tags in the webpage with the language tags in the language file;
obtaining a serial number of a database according to the language configuration; and
connecting to the database according to the serial number of the database and displaying data from the database in the webpage.

12. The non-transitory computer-readable medium of claim 11, wherein the method further comprising:
replacing the language tags in the webpage using the language tags in the language file corresponding to reset language configuration, and displaying data corresponding to the reset language configuration, in response to a determination that the language configuration is reset.

13. The non-transitory computer-readable medium of claim 11, wherein the language configuration corresponds to a language and comprises an identifier of the language.

14. The non-transitory computer-readable medium of claim 11, wherein the webpage is converted into a format of source code, and the language tags in the webpage are obtained from the source code of the webpage.

15. The non-transitory computer-readable medium of claim 11, wherein the language file corresponds to language configuration, and the language tags in the language file also correspond to the language configuration.
